(19) United States
(12) Patent Application Publication
(10) Pub. No.: US 2018/0245006 A1
(43) Pub. Date: Aug. 30, 2018

(54) COPPER ADSORBENT FOR ACETYLENE CONVERTER GUARD BED

(71) Applicant: UOP LLC, Des Plaines, IL (US)

(72) Inventors: Vladislav I. Kanazirev, Arlington Heights, IL (US); Jayant K. Gorawara, Buffalo Grove, IL (US); Stephen Caskey, Lake Villa, IL (US)

(21) Appl. No.: 15/969,469

(22) Filed: May 2, 2018

Related U.S. Application Data
(63) Continuation of application No. PCT/US2016/056825, filed on Oct. 13, 2016.
(60) Provisional application No. 62/253,412, filed on Nov. 10, 2015.

(51) Int. Cl. C10G 67/06; B01D 53/52; B01D 53/82; B01J 20/02; B01J 20/30; B01J 20/28

(52) U.S. Cl. CPC C10G 67/06; B01D 53/52; B01D 53/82; B01J 20/0237; B01J 20/3078; C10G 2300/202; B01D 2253/1122; B01D 2253/1124; B01D 2253/25; C10G 2300/205; B01J 20/28011

(57) ABSTRACT

Copper sorbents which are resistant to the reduction by hydrogen are used as a guard bed for an acetylene conversion zone. The adsorbents include cuprous oxide, cupric oxide, copper metal, and a halide and are pre-reduced prior to be loaded into the guard bed. The sorbents can remove contaminants that would poison selective hydrogenation catalysts used for a selectively hydrogenating acetylenic compounds in an olefin stream. The sorbents may also selectively hydrogenate the acetylenic compounds.

### CROSS-REFERENCE TO RELATED APPLICATIONS

This application is a Continuation of copending International Application No. PCT/US2016/056825 filed Oct. 13, 2016, which application claims priority from U.S. Provisional Application No. 62/253,412 filed Nov. 10, 2015, now expired, the contents of which cited applications are hereby incorporated by reference in their entirety.

### FIELD OF THE INVENTION

This invention relates generally to acetylene converters, and more particularly to a guard bed for an acetylene converter, and even more particularly to a new sorbent configured to remove contaminants from a feed stream to an acetylene converter.

### BACKGROUND OF THE INVENTION

Olefins, including ethylene and propylene, may be converted into a multitude of intermediate and end products, such as polymeric materials, on a large scale. Commercial production of olefins is mostly accomplished by the thermal cracking of hydrocarbons. Unfortunately, due to the very high temperatures involved, these commercial olefin producing processes also yield a substantial amount of less desired acetylenic (alkyne) impurities such as acetylene, methylacetylene, and C4 alkynes which contaminate the desired olefin streams. Therefore it is desirable to remove the acetylenic impurities from the olefins.

The separation of acetylenic impurities from olefins can considerably increase a cost of a plant. Several methods are known for separating an organic gas containing unsaturated linkages from gaseous mixtures. These include, for instance, cryogenic distillation, liquid absorption, membrane separation and pressure swing adsorption in which adsorption occurs at a higher pressure than the pressure at which the adsorbent is regenerated. Cryogenic distillation and liquid absorption are common techniques for separation of carbon dioxide and alkenes from gaseous mixtures containing molecules of similar size, e.g., nitrogen or methane. However, both techniques have disadvantages such as high capital cost and high operating expenses. Additionally, liquid absorption processes result in loss of solvent and thus, require a complex solvent make-up and recovery system.

A selective hydrogenation (SH) reaction with hydrogen in presence of supported metal catalysts is another common method for removal of the acetylenic impurities from the olefin streams. Accordingly, it is known that acetylenic impurities can be selectively hydrogenated and thereby removed from such product streams by passing the product stream over an acetylene hydrogenation catalyst in the presence of hydrogen gas. For example, palladium, and modified palladium, copper with some additives can be used also as a catalyst for selective hydrogenation. See, e.g., U.S. Pat. No. 3,912,789, U.S. Pat. No. 4,440,956, U.S. Pat. No. 3,755,488, U.S. Pat. No. 3,792,981, U.S. Pat. No. 3,812,057 and U.S. Pat. No. 4,425,255.

Typically, these noble metal catalysts require a guard bed containing a sorbent or other material that is capable of removing other contaminants such as oxygenates, arsine, phosphine, carbonyl sulfide, and mercury that may be in the stream with the acetylenic impurities. While various metal oxides in a sorbent could react with such impurities, the presence of hydrogen, a reducing agent, used in the selective hydrogenation may limit or impair the ability of the sorbent in the guard bed to remove these contaminants.

For example, U.S. Pat. No. 6,124,517 discloses the removal of acetylenes from olefin streams by adsorption in absence of hydrogen over a copper-alumina adsorbent containing Cu in a reduced, zero covalent state. Hydrogen containing gas is then used to regenerate the adsorbent. Additionally, U.S. Pat. No. 7,393,993 describes a method for purification of hydrocarbon streams in the absence of hydrogen through the use of a metal oxide on a support, preferably a copper oxide-alumina catalyst. In the process, acetylenes are partially converted to the corresponding olefins without production of saturated hydrocarbons. Thus, while these materials may be able to remove some of the contaminants, these processes are conducted in conditions that are void of hydrogen to avoid the reduction of the copper or copper oxide. Therefore, the metal oxides of the sorbent may not be able to efficiently and effectively remove the contaminants in the stream if the stream includes hydrogen. In order to address this problem, lead oxide, which is resistant to reduction from hydrogen gas, has been used. However, lead oxide has drawbacks due to its detrimental environmental impact and its low efficiency for contaminant removal.

Accordingly, it would be desirable to have sorbent that, in the presence of hydrogen, can efficiently and effectively act as a guard bed for selective hydrogenation catalysts without utilizing lead oxide. Furthermore, it would also be desirable if the material could also be configured to catalyze a selective hydrogenation of acetylenic impurities. The present invention is directed at providing solutions to these shortcomings.

### SUMMARY OF THE INVENTION

It has been found that calcination of intimately mixed solid mixtures of basic copper carbonate (abbreviated herein as “BCC”) and halide salt powder led to a material that was more difficult to reduce than the one prepared from BCC in absence of any salt powder. The resultant material provides copper states that are more resistant to being completely reduced by reducing agents like hydrogen. It was discovered that the presence of hydrogen can surprisingly provide a copper sorbent that includes copper metal, as well as both cupric oxide and cuprous oxide. It was further discovered that such reduction of the copper carbonate occurs at surprisingly low temperatures, allowing the sorbents to be used much more readily at start up compared to conventional sorbents.

The resultant sorbent can be used to also remove contaminants comprising mercury, arsenic, phosphine, and sulfur compounds from a liquid or gas stream, such as a stream feed to an acetylene converter. Additionally, due to the presence of the copper metal in the sorb ent, as well as the presence of hydrogen, the resultant sorbent can also be utilized to remove acetylenic impurities by catalyzing selective hydrogen of the acetylenic impurities.

Therefore, in a first aspect of the present invention, the present invention may be characterized broadly as providing a process for removing contaminants from a stream by: contacting an olefin stream comprising olefins with a sorbent in a contaminant removal zone, wherein the sorbent comprises copper, cupric oxide, cuprous oxide, and a halide; selectively removing one or more contaminants selected from a group consisting of mercury, arsenic, phosphine and sulfur compounds from the olefin stream; and, selectively converting acetylenic compounds from the olefin stream to olefins within an acetylene conversion zone, wherein the acetylene conversion zone receives a hydrogen gas.

The sorbent may further comprise a porous support material. The porous support material may be selected from a group consisting of alumina, silica, silica-aluminas, silicates, aluminates, silico-aluminates, zeolites, titania, zirconia, hematite, ceria, magnesium oxide, and tungsten oxide. The support material may comprise a transition alumina formed by a flash calcination of aluminum hydroxide.

The olefin stream may comprise a refinery off gas stream.

The sorbent may comprise from approximately 0.05 to 2 wt % of the halide.

The sorbent may comprise from approximately 1 to approximately 35 wt % copper.

The sorbent may be at least partially sulfided.

In a second aspect of the present invention, the present invention may be broadly characterized as providing a process for removing contaminants from a stream by: passing an olefin stream comprising olefins, hydrogen, acetylenic compounds and one or more contaminants selected from a group consisting of mercury, arsenic, phosphine and sulfur compounds to a contaminant removal zone, wherein the contaminant removal zone comprises a sorbent configured to selectively remove one or more contaminants from the olefin stream, wherein the sorbent comprises copper, cupric oxide, cuprous oxide, and a halide; removing one or more contaminants from the olefin stream with the sorbent; and, selectively converting acetylenic compounds from the olefin stream to olefins, wherein at least a portion of the acetylenic compounds are converted with the sorbent.

The process may further comprise loading pristine sorbent into the contaminant removal zone before the olefin stream is passed to the contaminant removal zone, and reducing the sorbent with hydrogen from the olefin stream. The olefin stream may comprise a refinery off gas stream.

The sorbent may comprise from approximately 0.05 to 2 wt % of the halide.

The sorbent may further comprise a porous support material selected from a group consisting of alumina, silica, silica-aluminas, silicates, aluminates, silico-aluminates, zeolites, titania, zirconia, hematite, ceria, magnesium oxide, and tungsten oxide.

The sorbent may comprises from approximately 1 to approximately 35 wt % copper and wherein cuprous oxide comprises from approximately 45 to approximately 75% of the copper in the sorbent.

The sorbent may be at least partially sulfided.

In a third aspect of the present invention, the present invention may be generally characterized as providing a process for removing contaminants from a stream by: forming a sorbent from a mixture of a support material, a basic copper carbonate, and a halide material; calcinating and activating the sorbent at a temperature of no more than 160° C.; loading the sorbent into a contaminant removal zone after the sorbent has been calcined and activated; passing an olefins stream to the contaminant removal zone, the olefin stream comprising olefins and one or more contaminants selected from the group consisting of mercury, arsenic, phosphine and sulfur compounds from the olefins stream; removing at least one of the one or more contaminants from the olefin stream with the sorbent; and, selectively converting acetylenic compounds from the olefin stream to olefins in the presence of hydrogen.

The acetylene conversion zone may be configured to receive a refinery off gas stream.

The sorbent may comprises a plurality of particles and at least some of the particles have a 7×14 mesh size. The particles may comprise porous beads with a bulk density from 640 kg/nr (to 1280 kg/nr.

The sorbent may be formed by co-nodulizing the basic copper carbonate and a calcined alumina as the support.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

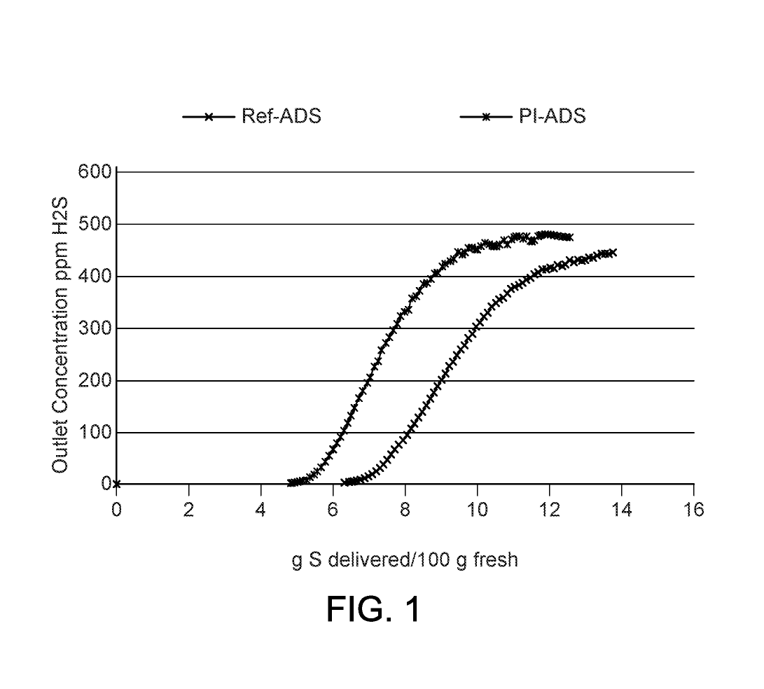

FIG. 1 shows a graphical comparison of the ambient temperature hydrogen sulfide capacity for a sorbent produced according to the present invention and a sorbent having the same level of copper produced according to prior art processes; and,

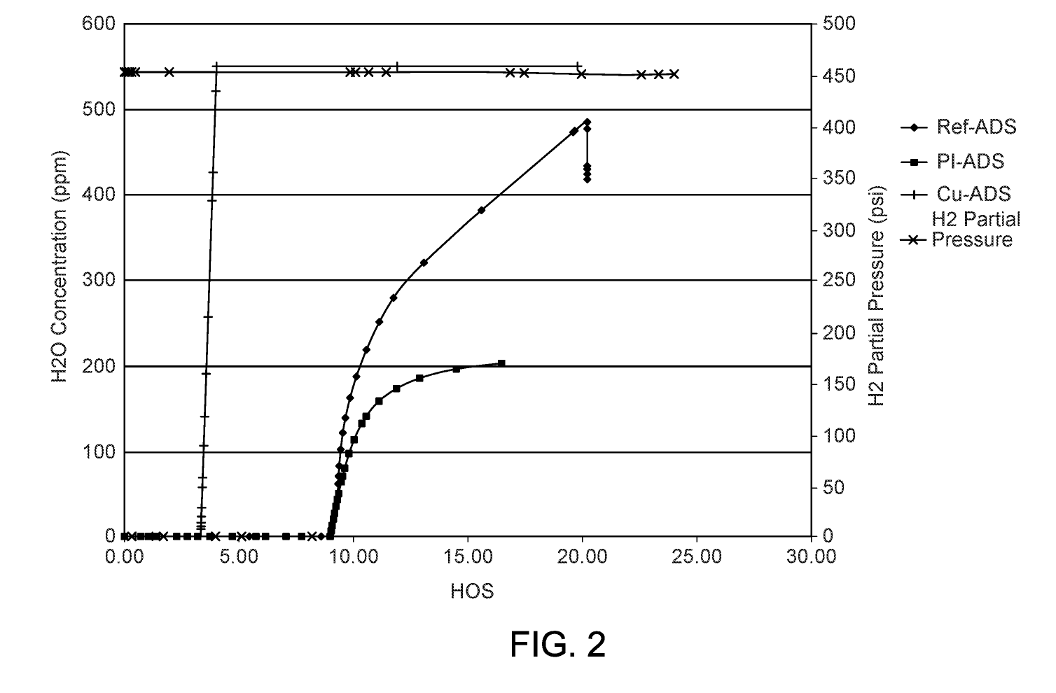

FIG. 2 shows a graphical comparison of the water production for a sorbent produced according to the present invention and sorbents produced according to prior art processes.

### DETAILED DESCRIPTION OF THE INVENTION

As mentioned above, the present invention provides one or more processes for removing contaminants comprising mercury, arsenic, phosphine, and sulfur compounds from hydrogen containing gas streams using copper adsorbents, in particular sorbents containing copper metal, cupric oxide and cuprous oxide. Additionally, the presence of the copper metal in the sorbent will allow for some of the acetylenic impurities to be removed by being selectively hydrogenated. In contrast to the current technologies, the sorbent is pre-reduced to a condition of having copper phases in different oxidation states. Accordingly while the sorbents of the prior art and the sorbents of the present invention may have the same active components, the presence of the oxidized copper in the sorbents of the present invention will lower the ability of the active copper to be reduced to copper metal and copper oxides. Thus, when the sorbent is loaded in to a bed, it has already been reduced and does not require further reduction via hydrogen gas, for example, even though the sorbents contains copper metal to begin processing the stream. The presence of oxidized copper such as cupric oxide (CuO) and cuprous oxide (Cu₂O) enhance the driving force and the efficiency for removing contaminants such as arsine, phosphine, carbonyl sulfide, hydrogen sulfide and mercury compounds to low ppb levels, as well as catalyze the selective hydrogenation of the acetylenic impurities.

With these general principles in mind, one or more embodiments of the present invention will be described with the understanding that the following description is not intended to be limiting.

A sorbent may be produced by combining an inorganic halide with a basic copper carbonate to produce a mixture and then the mixture is calcined for a sufficient period of time to decompose the basic copper carbonate into various phases of oxidation. It has been found that curing and activation at temperatures not exceeding 165° C. (329° F.) will provide the sorbent with the preferred composition. This temperature allows for the controlled formation of cuprous oxide without over reduction of the metal. Due to the temperature of activation, less than 165° C. (329° F.), the majority of the copper is preferably cuprous oxide. A minimum activation temperature of 40° C. (104° F.) may be used with the appropriate processing conditions, particularly if the partial pressure of the reducing gas(es) exceeds approximately 3.4 MPag (500 psig) and the sorbent is treated for approximately 10 hours.

Preferably, the sorbents comprises from approximately 1 to 35 weight percent (wt %) total copper, or from approximately 5 to approximately 30 wt % total copper, or from 7 to 25 wt % total copper. Throughout this application, the amount of copper by weight percent is calculated as elemental copper. By “approximately” it is meant that value includes +/−5%, or +/−2%, or +/−1%. In at least one embodiment, approximately 22 wt % of the sorbents comprise cuprous oxide, such that cuprous oxide comprises from approximately 45 to approximately 75%, or from approximately 55 to approximately 65%, or more than 50% of the total copper in the sorbent.

If the same material is used both for the guard bed for the selective hydrogenation zone as well as the selective hydrogenation zone, some differences of the amount of active phase material may appear due to the different compositions of the gas at the selective hydrogenation zone compared to the guard bed. For example, it is believed that the proportion of the metal copper of the sorbent in the selective hydrogenation zone may be increased compared to the portion of the metal copper of the sorbent in the guard bed. In some instances, the guard bed for the selective hydrogenation zone may be disposed within the same vessel as the selective hydrogenation zone. Alternatively, the guard bed for the selective hydrogenation zone may be disposed in a separate vessel.

The sorbent may be prepared via a known procedure of co-nodulizing. For example, approximately 40% basic Cu carbonate (BCC) and 60% flash calcined alumina (FCA) may be co-formed in a water sprayed rotating pan. An alkali metal halide, such as NaCl or the like, is sprayed into the pan to produce particles. In at least one embodiment, the particles have a 7×8 mesh size or a 5×8 mesh size and may comprise porous beads with a bulk density from 640 kg/nr (40 lbs/ft³) to 1280 kg/nr (80 lbs/ft³). However, other sizes may be used depending on the use. The resultant particles are cured and activated at temperatures not exceeding 165° C. (329° F.). The sorbent may also be sulfided, or partially sulfided, which is particularly desirable when a high efficiency mercury removal at startup of the process is required.

Another way to practice the invention is to mix solid chloride salt and metal oxide precursor (carbonate in this case) and to subject the mixture to calcinations to achieve conversion to oxide. Prior to the calcinations, the mixture can be co-formed with a carrier such as porous alumina. The formation process can be done by extrusion, pressing pellets or nodulizing in a pan or drum nodulizer.

Various forms of basic copper carbonate may be used with a preferred form being synthetic malachite, CuCO₃.Cu(OH)₂. Basic copper carbonates such as CuCO₃.Cu(OH)₂ can be produced by precipitation of copper salts, such as Cu(NO)₃, CuSO₄ and CuCl₂, with sodium carbonate. Depending on the conditions used, and especially on washing the resulting precipitate, the final material may contain some residual product from the precipitation process. In the case of the CuCl₂ raw material, sodium chloride is a side product of the precipitation process. It has been determined that a commercially available basic copper carbonate that had both residual chloride and sodium, exhibited lower stability towards heating and improved resistance towards reduction than another commercial BCC that was practically chloride-free.

To produce the sorbents according to the present invention, agglomerates may be formed which comprise a support material, copper oxides, copper metal and halide salts. The support material is preferably a porous support material and may be selected from the group consisting of alumina, silica, silica-aluminas, silicates, aluminates, silico-aluminates, zeolites, titania, zirconia, hematite, ceria, magnesium oxide, and tungsten oxide. The alumina is typically present in the form of transition alumina which comprises a mixture of poorly crystalline alumina phases such as “rho”, “chi” and “pseudo gamma” aluminas which are capable of quick rehydration and can retain substantial amount of water in a reactive form. An aluminum hydroxide Al(OH)₃, such as Gibbsite, is a source for preparation of transition alumina. The typical industrial process for production of transition alumina includes milling Gibbsite to 1 to 20 microns particle size followed by flash calcination for a short contact time as described in the patent literature such as in U.S. Pat. No. 2,915,365. Amorphous aluminum hydroxide and other naturally found mineral crystalline hydroxides e.g., Bayerite and Nordstrandite or monoxide hydroxides (AlOOH) such as Boehmite and Diaspore can be also used as a source of transition alumina.

The sorbent that contains the halide salt exhibits a higher resistance to reduction than does a similar sorbent that is made without the halide salt. The preferred inorganic halides are sodium chloride, potassium chloride or mixtures thereof. Bromide salts are also effective. The chloride content in the sorbent may range from 0.05 to 2.5 wt %.

The sorbents can be used to remove various contaminants, such as hydrogen sulfide, carbonyl sulfide, arsine and phosphine, from a stream containing acetylenic impurities at nearly ambient temperature even in the presence of hydrogen. It is believed that one particular advantageous use of the sorbents is with a refinery off gas. A refinery off gas may comprise a gaseous stream formed from one or more different units within a refinery. The refinery off gas may include, for example, a portion of an effluent of a steam cracker unit and a gaseous stream from a fluidized catalytic cracking (FCC) unit. These units are well known in the art, and produce olefinic streams that include some acetylenic impurities, as well as other contaminants, such as hydrogen sulfide, carbonyl sulfide, arsine and phosphine. The quality of the refinery off gas depends upon the refinery configuration, the severity of cracking units (such as an FCC unit or a coker cracking unit), and the quality of refinery crude. Some refineries use these gases as fuel, while other refineries may flare the gas when excess gas is produced. This refinery off gas contains valuable components such as hydrogen, and light olefins—primarily ethylene and propylene as well as light paraffins such as ethane and propane. For refiners having a large crude processing capacity at a single site—a refiner can reduce emissions and generate additional margins by recovering the olefins and using the paraffins as feedstock for an existing steam cracker. However, these options all require removal of trace contaminants present in the refinery off gases. Thus, the sorbents of the present invention are particularly beneficial in processes for treating such refinery off gases.

The sorbents according to the present invention have a low heat generation and low water evolution in the presence of hydrogen gas at temperatures below 50° C. (122° F.) in lab testing. This eliminates a major disadvantage of the copper based sorbents at startup in which the non-modified copper carbonate can easily reduce to copper metal at temperatures from 45 to 55° C. (113 to 131° F.).

Unlike sorbents which only contain metal obtained by pre-reduced copper oxide, the sorbents according to the present invention will, without any further pretreatment or loading steps remove hydrogen sulfide from the stream by the following reactions:

CuO+H₂S(g)=CuS+H₂O(g); and,

Cu₂O+H₂S(g)=Cu₂S+H₂O(g).

Additionally, in addition converting mercaptans to disulfides, the sorbents according to the present invention also remove mercaptans by reaction with the cuprous oxide:

2CuO+2RSH=Cu₂O+RS—SR+H₂O; and,

Cu₂O+2RSH=2CuSR+H₂O.

A comparison between a sorbent according to the present invention (PI-ADS), and a copper sorbent produced with an activation temperature above the 165° C. (329° F.) (Ref-ADS) is shown in FIG. 1. The test was conducted in a flow reactor with nitrogen containing approximately 500 ppm hydrogen sulfide.

The PI-ADS was additionally treated off site in a flow of hydrogen gas at temperatures from 40 to 150° C. (104 to 302° F.) to simulate the reducing atmosphere encountered in a synthesis gas application. This treatment led to a partial reduction of the copper in the sorbent resulting in a sorbent having a mixture of copper phases, namely, copper metal, cuprous oxide, and cupric oxide. The copper phase composition was verified by X-ray analysis. In contrast, the Ref-ADS contained only the cupric oxide copper phase produced by thermal decomposition of the copper carbonate precursor at temperatures above 165° C. (329° F.) in the activation process.

FIG. 1 shows that the sorbent according to the present invention (PI-ADS) had only a slightly lower capacity for hydrogen sulfide adsorption. This is an expected outcome since the content of the cupric oxide, which is the most potent phase in the hydrogen sulfide removal process, is smaller in the sorbent according to the present invention (PI-ADS), but fully adequate for the complex synthesis gas purification involving a variety of contaminants. It is expected that the sulfur capacity can be increased with a higher amount of copper in the PI-ADS sorbent.

FIG. 2 shows the results of another test in which the sorbent according to the present invention (PI-ADS) produced less water when exposed to high hydrogen partial pressures (approximately 3,100 kPa (450 psi)), at 40° C. (104° F.) in a flow reactor. The copper sorbent produced with an activation temperature above the 165° C. (329° F.) (Ref-ADS), which also contained a chloride additive, showed significantly larger water evolution while a standard cupric oxide sorbent (Cu-ADS) that did not contain a chloride additive demonstrated massive water evolution even at a shorter time on stream.

The behavior of the sorbents according to the present invention (PI-ADS) is beneficial in many ways. Besides the lower water evolution, which is undesirable upstream of a reaction zone having a noble metal catalyst, there is much less heat generated in the reduction process and better opportunity to control the process and avoid runaway exothermic reactions. The X-ray analysis of the materials after the test confirms the presence of oxide phases in PI-ADS which is beneficial for removal of other contaminants such as arsine and phosphine from the olefin stream which includes acetylenic components. Thus, the sorbents can be used to efficiently remove contaminants from an olefin stream which includes acetylenic components.

Accordingly, in at least one aspect of the present invention, a guard bed for a selective hydrogenation zone can be loaded with sorbent according to the present invention. As mentioned above, the guard bed may be disposed in the same vessel as the selective hydrogenation zone, it may be disposed in a separate vessel. An olefin stream comprising olefins, as well as one or more contaminants such as mercury, arsenic, phosphine and sulfur compounds, as well as acetylenic impurities may be passed through the guard bed. No further steps of reduction of the sorbent are required, and upon startup may begin immediately processing the stream.

The olefin stream may include hydrogen which is used for the selective hydrogenation of the acetylenic impurities to olefins. Alternatively, separate hydrogen containing gas may be passed to the selective hydrogenation zone. The sorbent will remove one or more contaminants to purify the stream even in the presence of hydrogen, which is a reducing agent. Additionally, the sorbent may also act as a catalyst for the selective hydrogenation of the acetylenic impurities to olefins as a result of the hydrogen present.

After some time, the sorbent may be removed from the bed, and replaced with pristine, i.e., unused, sorbent, and the vessel may be placed back into service—with the stream being passed to the pristine sorbent without any further steps of reduction of the sorbent.

When placed in service the sorbent will provide savings not only in shortening and simplifying the startup of the unit but also in increased capacity. Additionally, for newer units the sorbent will allow for designing smaller beds and substantial savings.

### Specific Embodiments

While the following is described in conjunction with specific embodiments, it will be understood that this description is intended to illustrate and not limit the scope of the preceding description and the appended claims.

A first embodiment of the invention is a process for removing contaminants from a stream, the process comprising contacting an olefin stream comprising olefins with a sorbent in a contaminant removal zone, wherein the sorbent comprises copper, cupric oxide, cuprous oxide, and a halide; selectively removing one or more contaminants selected from a group consisting of mercury, arsenic, phosphine and sulfur compounds from the olefin stream; and, selectively converting acetylenic compounds from the olefin stream to olefins within an acetylene conversion zone, wherein the acetylene conversion zone receives a hydrogen gas. An embodiment of the invention is one, any or all of prior embodiments in this paragraph up through the first embodiment in this paragraph wherein the sorbent further comprises a porous support material. An embodiment of the invention is one, any or all of prior embodiments in this paragraph up through the first embodiment in this paragraph, wherein the porous support material is selected from the group consisting of alumina, silica, silica-aluminas, silicates, aluminates, silico-aluminates, zeolites, titania, zirconia, hematite, ceria, magnesium oxide, and tungsten oxide. An embodiment of the invention is one, any or all of prior embodiments in this paragraph up through the first embodiment in this paragraph wherein the support material comprises a transition alumina formed by a flash calcination of aluminum hydroxide. An embodiment of the invention is one, any or all of prior embodiments in this paragraph up through the first embodiment in this paragraph, wherein the olefin stream comprises a refinery off gas stream. An embodiment of the invention is one, any or all of prior embodiments in this paragraph up through the first embodiment in this paragraph, wherein the sorbent comprises from approximately 0.05 to 2 wt % of the halide. An embodiment of the invention is one, any or all of prior embodiments in this paragraph up through the first embodiment in this paragraph, wherein the sorbent comprises from approximately 1 to approximately 35 wt % copper. An embodiment of the invention is one, any or all of prior embodiments in this paragraph up through the first embodiment in this paragraph, wherein the sorbent is at least partially sulfided.

A second embodiment of the invention is a process for removing contaminants from a stream, the process comprising passing an olefin stream comprising olefins, hydrogen, acetylenic compounds and one or more contaminants selected from a group consisting of mercury, arsenic, phosphine and sulfur compounds to a contaminant removal zone, wherein the contaminant removal zone comprises a sorbent configured to selectively remove one or more contaminants from the olefin stream, wherein the sorbent comprises copper, cupric oxide, cuprous oxide, and a halide; removing one or more contaminants from the olefin stream with the sorbent; and, selectively converting acetylenic compounds from the olefin stream to olefins, wherein at least a portion of the acetylenic compounds are converted with the sorbent. An embodiment of the invention is one, any or all of prior embodiments in this paragraph up through the second embodiment in this paragraph further comprising loading pristine sorbent into the contaminant removal zone before the olefin stream is passed to the contaminant removal zone; and, reducing the sorbent with hydrogen from the olefin stream. An embodiment of the invention is one, any or all of prior embodiments in this paragraph up through the second embodiment in this paragraph wherein the olefin stream comprises a refinery off gas stream. An embodiment of the invention is one, any or all of prior embodiments in this paragraph up through the second embodiment in this paragraph wherein the sorbent comprises from approximately 0.05 to 2 wt % of the halide. An embodiment of the invention is one, any or all of prior embodiments in this paragraph up through the second embodiment in this paragraph wherein the sorbent further comprises a porous support material selected from a group consisting of alumina, silica, silica-aluminas, silicates, aluminates, silico-aluminates, zeolites, titania, zirconia, hematite, ceria, magnesium oxide, and tungsten oxide. An embodiment of the invention is one, any or all of prior embodiments in this paragraph up through the second embodiment in this paragraph, wherein the sorbent comprises from approximately 1 to approximately 35 wt % copper and wherein cuprous oxide comprises from approximately 45 to approximately 75% of the copper in the sorbent. An embodiment of the invention is one, any or all of prior embodiments in this paragraph up through the second embodiment in this paragraph, wherein the sorbent is at least partially sulfided.

A third embodiment of the invention is a process for removing contaminants from a stream, the process comprising forming a sorbent from a mixture of a support material, a basic copper carbonate, and a halide material; calcinating and activating the sorbent at a temperature of no more than 160° C.; loading the sorbent into a contaminant removal zone after the sorbent has been calcined and activated; passing an olefins stream to the contaminant removal zone, the olefin stream comprising olefins and one or more contaminants selected from the group consisting of mercury, arsenic, phosphine and sulfur compounds from the olefins stream; removing at least one of the one or more contaminants from the olefin stream with the sorbent; and, selectively converting acetylenic compounds from the olefin stream to olefins in the presence of hydrogen. An embodiment of the invention is one, any or all of prior embodiments in this paragraph up through the third embodiment in this paragraph wherein the acetylene conversion zone receives a refinery off gas stream. An embodiment of the invention is one, any or all of prior embodiments in this paragraph up through the third embodiment in this paragraph, wherein the sorbent comprises a plurality of particles and at least some of the particles have a 7×14 mesh size. An embodiment of the invention is one, any or all of prior embodiments in this paragraph up through the third embodiment in this paragraph wherein the particles comprises porous beads with a bulk density from 640 kg/nr (40 lbs/ft3) to 1280 kg/nr (80 lbs/ft3). An embodiment of the invention is one, any or all of prior embodiments in this paragraph up through the third embodiment in this paragraph wherein the sorbent is formed by co-nodulizing the basic copper carbonate and a calcined alumina as the support.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A process for removing contaminants from a stream, the process comprising:
contacting an olefin stream comprising olefins with a sorbent in a contaminant removal zone, wherein the sorbent comprises copper, cupric oxide, cuprous oxide, and a halide;
selectively removing one or more contaminants selected from a group consisting of mercury, arsenic, phosphine and sulfur compounds from the olefin stream; and,
selectively converting acetylenic compounds from the olefin stream to olefins within an acetylene conversion zone, wherein the acetylene conversion zone receives a hydrogen gas.

2. The process of claim 1 wherein the sorbent further comprises a porous support material.

3. The process of claim 2, wherein the porous support material is selected from the group consisting of alumina, silica, silica-aluminas, silicates, aluminates, silico-aluminates, zeolites, titania, zirconia, hematite, ceria, magnesium oxide, and tungsten oxide.

4. The process of claim 3 wherein the support material comprises a transition alumina formed by a flash calcination of aluminum hydroxide.

5. The process of claim 1, wherein the olefin stream comprises a refinery off gas stream.

6. The process of claim 1, wherein the sorbent comprises from approximately 0.05 to 2 wt % of the halide.

7. The process of claim 6, wherein the sorbent comprises from approximately 1 to approximately 35 wt % copper.

8. The process of claim 1, wherein the sorbent is at least partially sulfided.

9. A process for removing contaminants from a stream, the process comprising:
passing an olefin stream comprising olefins, hydrogen, acetylenic compounds and one or more contaminants selected from a group consisting of mercury, arsenic, phosphine and sulfur compounds to a contaminant removal zone, wherein the contaminant removal zone comprises a sorbent configured to selectively remove one or more contaminants from the olefin stream, wherein the sorbent comprises copper, cupric oxide, cuprous oxide, and a halide;
removing one or more contaminants from the olefin stream with the sorbent; and,
selectively converting acetylenic compounds from the olefin stream to olefins, wherein at least a portion of the acetylenic compounds are converted with the sorbent.

10. The process of claim 9 further comprising:
loading pristine sorbent into the contaminant removal zone before the olefin stream is passed to the contaminant removal zone; and,
reducing the sorbent with hydrogen from the olefin stream.

11. The process of claim 10 wherein the olefin stream comprises a refinery off gas stream.

12. The process of claim 9 wherein the sorbent comprises from approximately 0.05 to 2 wt % of the halide.

13. The process of claim 9 wherein the sorbent further comprises a porous support material selected from a group consisting of alumina, silica, silica-aluminas, silicates, aluminates, silico-aluminates, zeolites, titania, zirconia, hematite, ceria, magnesium oxide, and tungsten oxide.

14. The process of claim 9, wherein the sorbent comprises from approximately 1 to approximately 35 wt % copper and wherein cuprous oxide comprises from approximately 45 to approximately 75% of the copper in the sorbent.

15. The process of claim 9, wherein the sorbent is at least partially sulfided.

16. A process for removing contaminants from a stream, the process comprising:
forming a sorbent from a mixture of a support material, a basic copper carbonate, and a halide material;
calcined and activating the sorbent at a temperature of no more than 160° C.;
loading the sorbent into a contaminant removal zone after the sorbent has been calcined and activated;
passing an olefins stream to the contaminant removal zone, the olefin stream comprising olefins and one or more contaminants selected from the group consisting of mercury, arsenic, phosphine and sulfur compounds from the olefins stream;
removing at least one of the one or more contaminants from the olefin stream with the sorbent; and,
selectively converting acetylenic compounds from the olefin stream to olefins in the presence of hydrogen.

17. The process of claim 16 wherein the acetylene conversion zone receives a refinery off gas stream.

18. The process of claim 16, wherein the sorbent comprises a plurality of particles and at least some of the particles have a 7×14 mesh size.

19. The process of claim 18 wherein the particles comprises porous beads with a bulk density from 640 kg/nr (40 lbs/ft3) to 1280 kg/nr (80 lbs/ft3).

20. The process of claim 16 wherein the sorbent is formed by co-nodulizing the basic copper carbonate and a calcined alumina as the support.
